(19) United States
(12) Patent Application Publication
(10) Pub. No.: US 2025/0075620 A1
(43) Pub. Date: Mar. 6, 2025

(54) RESERVOIR QUALITY PREDICTION AND PROCESSES FOR USING SAME

(71) Applicant: Schlumberger Technology Corporation, Sugar Land, TX (US)

(72) Inventors: Renata Ribeiro Gomes Ansaloni, Cairo (EG); Khaled Saleh, Dhahran (SA); Sherif Ghadiry, Dhahran (SA); Wael Abdallah, Dhahran (SA)

(21) Appl. No.: 18/461,115

(22) Filed: Sep. 5, 2023

(51) Int. Cl. E21B 49/08; G01V 1/46; G01V 1/50

(52) U.S. Cl. CPC E21B 49/087; G01V 1/46; G01V 1/50

(57) ABSTRACT

Processes for characterizing reservoir formations and directing downhole operations based on the characterized reservoir formations. In some embodiments, the process can include combining at least two downhole logs into input data. An interpretation method can be used to convert the input data into interpretative data. Elemental analysis can be used to convert the interpretative data into at least one formation model. Formation properties can be acquired from the at least one formation model. A reservoir quality classification can be created from the formation properties. The process can also include directing downhole operations using the reservoir quality classification to select a preferred downhole operation location.

### FIELD

Embodiments described generally relate to analyzing reservoir formations. More particularly, such embodiments relate to characterizing reservoir formations and directing downhole operations.

### BACKGROUND

Carbonate formations exhibit notable heterogeneity and complexity regarding pore structure and mineralogy. This complexity poses challenges for routine petrophysical measurements, particularly when determining porosity and permeability. The variations in mineralogy introduce uncertainties in grain density and porosity models derived from conventional tools such as density and neutron measurements. Moreover, the presence of secondary porosity, such as vugs (large pores), further complicates the reliability of permeability models in carbonate rocks. Nuclear magnetic resonance (NMR) logs have proven to be effective in measuring mineral-independent porosity and providing insights into the distribution of pore sizes under downhole conditions but are insufficient to evaluate an entire reservoir or cover all relevant reservoir factors.

A common commercial technique used to characterize the pore size distribution is mercury injection capillary pressure (MICP). It offers valuable insight into pore structure, connectivity, and fluid behavior of a formation. By injecting mercury into a controlled pressure environment, MICP analysis enables the measurement and characterization of capillary pressure, which is beneficial for understanding fluid flow and storage in porous media. This technique has proven valuable for evaluating reservoir rocks and estimating parameters such as permeability, irreducible water saturation, and pore throat sizes. However, MICP alone is insufficient to evaluate an entire reservoir without sampling every depth repeatedly.

There is a need, therefore, for improved processes for characterizing reservoir formations and directing downhole operations based on the characterized reservoir formation.

### SUMMARY

Processes for characterizing reservoir formations and directing downhole operations based on the characterized reservoir formations are provided. In some embodiments, the process can include combining at least two downhole logs into input data. An interpretation method can be used to convert the input data into interpretative data. Elemental analysis can be used to convert the interpretative data into at least one formation model. Formation properties can be acquired from the at least one formation model. A reservoir quality classification can be created from the formation properties. The process can also include directing downhole operations using the reservoir quality classification to select a preferred downhole operation location.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments. It is contemplated that elements disclosed in one embodiment can be utilized in other embodiments without specific recitation.

FIG. 1 depicts an illustrative workflow of a process for evaluating a reservoir formation, according to one or more embodiments described.

FIG. 2 depicts an illustrative workflow of an NMR factor analysis (NMR-FA) and sorting process, according to one or more embodiments described.

FIG. 3 depicts an illustrative example of a plurality of graphical outputs and results of the process, according to one or more embodiments described.

FIG. 4 depicts a schematic of an illustrative computing system that can be configured to carry out one or more steps in the process flow diagram depicted in FIG. 1, according to one or more embodiments described.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure can repeat reference numerals and/or letters in the various embodiments and across the figures provided herein. This repetition is for the purpose of simplicity and clarity and does not in itself dictate a relationship between the various embodiments and/or configurations. Moreover, the exemplary embodiments presented below can be combined in any combination of ways, i.e., any element from one exemplary embodiment can be used in any other exemplary embodiment, without departing from the scope of the disclosure.

Additionally, certain terms are used throughout the following description and claims to refer to particular components. As one skilled in the art will appreciate, various entities can refer to the same component by different names, and as such, the naming convention for the elements described herein is not intended to limit the scope of the invention, unless otherwise specifically defined herein. Further, the naming convention used herein is not intended to distinguish between components that differ in name but not function.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. Additionally, unless otherwise indicated herein, all numerical values are “about” or “approximately” the indicated value, meaning the values take into account experimental error, machine tolerances and other variations that would be expected by a person having ordinary skill in the art. It should also be understood that the precise numerical values used in the specification and claims constitute specific embodiments.

Furthermore, in the following discussion and in the claims, the terms “including” and “comprising” are used in an open-ended fashion, and thus should be interpreted to mean “including, but not limited to.”

The term “or” is intended to encompass both exclusive and inclusive cases, i.e., “A or B” is intended to be synonymous with “at least one of A and B,” unless otherwise expressly specified herein.

The indefinite articles “a” and “an” refer to both singular forms (i.e., “one”) and plural referents (i.e., one or more) unless the context clearly dictates otherwise. For example, embodiments using “an optical density difference” includes embodiments where one, two, or more optical density differences are used, unless specified to the contrary or the context clearly indicates that only one optical density difference is used.

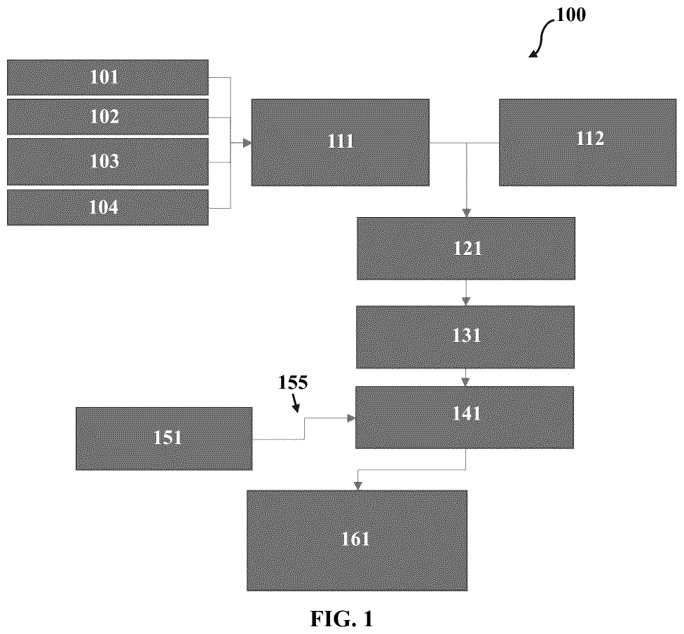

FIG. 1 depicts an illustrative workflow 100 of a process for evaluating a reservoir formation, according to one or more embodiments. The workflow 100 can include combining at least two downhole logs into input data. The downhole logs can be or can include open-hole logs 111 and/or cased-hole logs 112. Illustrative downhole logs can be or can include, but are not limited to, one or more induction resistivity logs 101, one or more bulk density logs 102, one or more epithermal neutron porosity logs 103, one or more NMR logs 104, or the like, and/or any combination thereof. In some embodiments, the at least two downhole logs can be combined into input data. The input data can be converted into interpretive data via an interpretation method 121. In some embodiments, the interpretation method can include exploratory factor analysis. In some embodiments, the interpretive data can be or can include, but is not limited to, geological facies information.

The interpretative data from the interpretation method 121 can be provided for an elemental analysis 131. The elemental analysis 131 can be used to convert the interpretative data from the interpretation method 121 to create one or more formation models. In some embodiments, the formation model can be a modeled reservoir and/or formation that can be based on formation depth, geological facies, and the like. The formation model created by the elemental analysis 131 can contain one or more formation properties 141.

In some embodiments, a routine core analysis 151 can be used to validate 155 the formation properties 141. In some embodiments, routine core analysis 151 can be used to determine properties such as porosity, permeability, and fluid saturation. In some embodiments, the routine core analysis 151 can include MICP analysis. Integrating or comparing the formation properties 141 with the routine core analysis data can serve as a validation step to confirm the accuracy and reliability of the formation properties 141 obtained from the formation model. The formation properties 141 can be used to provide formation results 161.

In some embodiments, the formation results 161 can provide one or more reservoir quality classifications. The reservoir quality classification(s) can include, but are not limited to, favorable production locations, unfavorable production locations, predictive drilling results, and the like, and/or any combination thereof. The reservoir quality classification(s) can provide a user with qualitative information about the reservoir and formation that can be used to direct downhole operations. Illustrative downhole operations that can be carried out based on the reservoir quality classification can be or can include, but are not limited to, hydrocarbon production, condensate production, perforation, drilling, and the like, or any combination thereof. A preferred downhole operation location can be selected by a user based on one or more downhole operations and/or one or more reservoir quality classifications.

In some embodiments, an NMR factor analysis (NMR-FA) method can be used to find depth intervals (or groups of locations) with similar petrophysical properties, such as pore space and fluid properties. In some embodiments, T² cutoff-based methods, such as the porosity partitioning and permeability analysis (P3A) method, can be used to classify pore spaces so as to find depth intervals (or groups of locations) with similar petrophysical properties. The factor analysis method for characterizing locations of similar petrophysical properties can be as described in U.S. Patent Application Publication No. US2014/0114576, and Jain, V., et al., Characterization of Underlying Pore and Fluid Structure Using Factor Analysis on NMR Data, SPWLA 54th Annual Logging Symposium (Jun. 22-26, 2013), which are both incorporated by reference herein. Factor analysis can group together poro-fluid distributions. Due to the factors that influence a T² distribution, these poro-fluid classes can include similar pore size distributions as well as similar fluid types.

The P3A method can be as described in Ramamoorthy, R., et al., A New Workflow for Petrophysical and Textural Evaluation of Carbonate Reservoirs, SPWLA 49th Annual Logging Symposium, (May 25-28, 2008), which is incorporated by reference herein. This method can use two user-defined cutoffs to divide the T² (transverse relaxation) distribution into three pore types: micro-pores, meso-pores, and macro-pores. These three pore types can be combined to determine a pore-type classification based on the relative abundance of the three pore types. Thus, locations (depths) in the wellbore where the abundance of the different pore sizes match can be used to define depth intervals (or groups of locations).

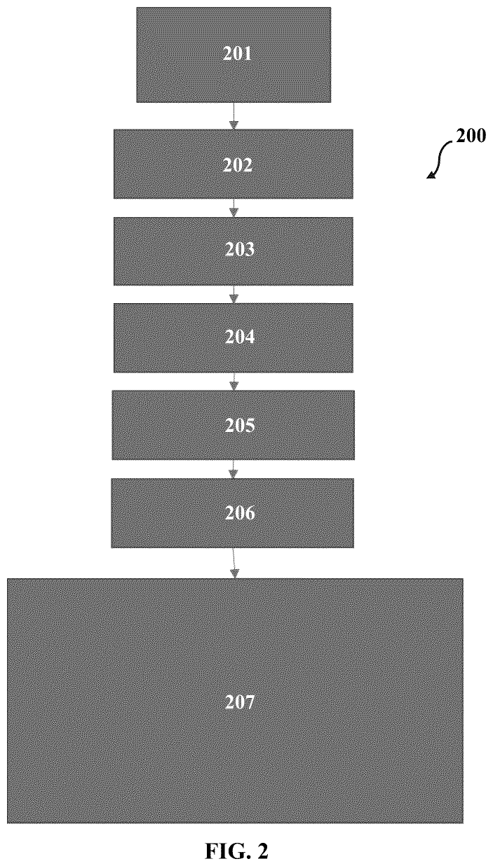

FIG. 2 depicts an illustrative workflow 200 of an NMR-FA and sorting process, according to one or more embodiments. The workflow 200 can be a more detailed illustration of the interpretation method 121, shown in FIG. 1. The workflow 200 can begin with a data preparation step 201. The data preparation step 201 can provide information for an NMR-FA step 202. The NMR-FA step 202 can provide porosity and fluid distribution data 203, fluid volume data 204, and/or free and bound fluid data 205. The NMR-FA step 202 can also provide T² cutoff values for a porosity and permeability analysis step 206. The porosity and permeability analysis step 206 can include use of the following equations:

$$\begin{matrix}{K}_{S D R} = {a ( φ )}^{2} {( d * {T}_{2 l m} )}^{2} \\ {K}_{macro} = {c ( φ )}^{2} {( ( {φ}_{micro} ) / ( {φ}_{m e s o} + {φ}_{micro} ) )}^{2}\end{matrix}$$

where K_{SDR} is a permeability equation, where φ is the total porosity fraction, ρ is T² surface relaxivity, and T₂ₗₘ is the T² logarithmic mean from the NMR log, and where K_{macro} is a macroporosity equation, where c is a constant adjusted to the specific formation, and V_{macro} is the macroporosity fraction based on borehole electrical image log analysis and/or NMR log analysis. In some more embodiments, the porosity and permeability analysis step 206 can include the P3A method described above.

### Example

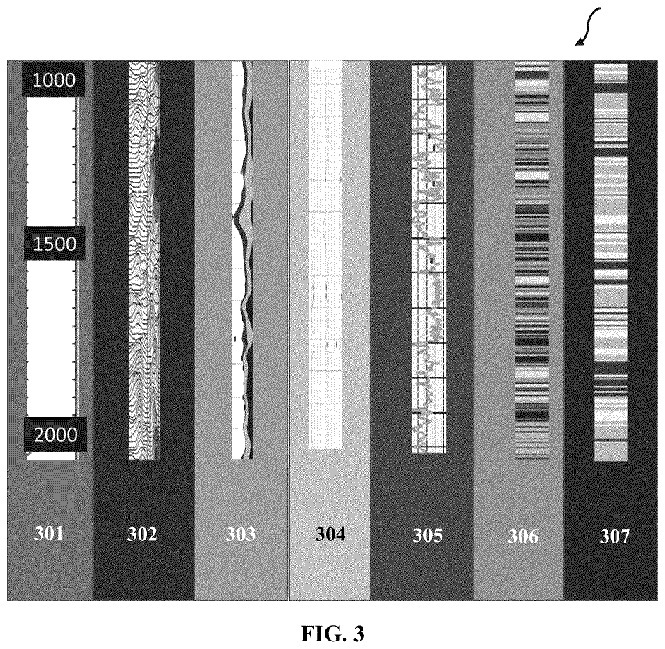

FIG. 3 depicts an illustrative example 300 of a plurality of graphical outputs and results of the process, according to one or more embodiments. As shown in FIG. 3, the example 300 can be a visual example of the formation model created by the elemental analysis 131 step. A formation depth chart 301 can show the depth of the reservoir in any appropriate unit of length. The formation depth chart 301 can be used as a location guide for the other charts shown in the example 300. In some embodiments, the results obtained from the NMR-FA step 202, as shown in FIG. 2, can be shown in an NMR-T² distribution and T² cutoffs chart 302. In some embodiments, the porosity and fluid distribution data 203, fluid volume data 204, and/or free and bound fluid data 205, as shown in FIG. 2, can be shown in an NMR cumulative pore volumes and porosity chart 303 and/or a micro/meso/macro pores volume chart 304. In some embodiments, the results obtained from the porosity and permeability analysis step 206, as shown in FIG. 2, can be shown in a permeability chart 305. In some embodiments, the data shown in charts 301, 302, 303, 304, and/or 305 can be analyzed in formation results 161, as shown in FIG. 1, to create an NMR poro-fluid facies chart 306. In some embodiments, the NMR poro-fluid facies chart 306 can combine acquired and analyzed data to determine fluid and pore characteristics at a plurality of geological facies within the formation or reservoir. The formation results 161, as shown in FIG. 1, can also be used to create a reservoir quality classification chart 307. The reservoir quality classification chart 307 can use the NMR poro-fluid facies chart 306 to qualify each geological facies as having favorable, unfavorable, and/or some other qualified condition for one or more downhole operations as determined by a user. The favorable conditions shown in reservoir quality classification chart 307 can show preferred downhole operation locations based upon the formation depth and/or geological facies. In one or more embodiments, the downhole operations can include operations that require producible hydrocarbon porosity predictions, carbonate formation permeability predictions, or the like, and/or any combination thereof.

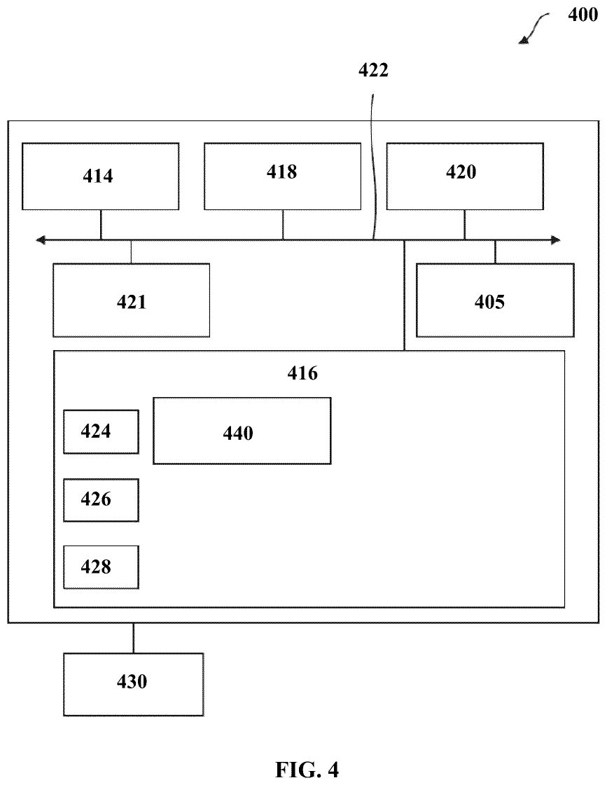

FIG. 4 depicts a schematic of an illustrative computing system 400 that can be configured to carry out one or more steps in the process flow diagram depicted in FIG. 1, according to one or more embodiments. The computer system 400 can be located within a facility or can be located elsewhere. One or more chips, for example chips 405 and/or 421, can be or can include field-programmable gate arrays (“FPGAs”), application specific integrated circuits (“ASICs”), chiplets, Multi-Chip-Modules, central processing units (“CPUs”), and/or system-on-chips (“SOCs”), to name a few. The chip can be used in a wide-range of applications, including but not limited to image processing, input data organization, or other digital processing systems. The ASICs can include entire microprocessors, memory blocks including read only memory (ROM), random access memory (RAM), erasable programmable read only memory (EPROM), electrically erasable programmable read only memory (EEPROM), flash memory and other building blocks and can be known as system-on-chip (“SoC”).

To achieve its desired functionality, the computing system 400 can include various hardware and software components. Among these components can be one or more processors 414 and a command actuator 440. These hardware components can be interconnected through the use of a number of electrical connections, buses, and/or network connections. In one embodiment, the processor 414, the chip 405, the chip 421, and the command actuator 440 can be communicatively coupled via a bus 422. The bus 422 can be or include any know computing system bus. The command actuator 440 can be internal to a data storage device 416.

The chip 405, the chip 421, and/or the command actuator 440 can include, either separately or in some combination, software and hardware, including tangible, non-transitory computer readable medium (not shown), for performing reservoir analysis. In some embodiments, the reservoir analysis can be interpreted via statistical formulas, such as average mean, median, standard deviation, and the like, or any combination thereof, and/or complex formulas, such as factor analysis, Fourier's transform, logarithmic methods, and the like, or any combination thereof. Other known algorithms and/or suitable algorithms developed in the future can also be used. In some embodiments, the command actuator 440 can be integrated into the chip 405, the chip 421, and/or the processor 414. In some embodiments, the chip 405 and/or the chip 421 can be integrated into the processor 414. Although the command actuator 440 is depicted as being internal to the data storage device 416, in other embodiments, the command actuator 440 can be a peripheral device (not shown) coupled to the computing system 412 or included within a peripheral device (not shown) coupled to the computing system 412.

The command actuator 440 can include instructions that when executed by the command actuator 440 can cause the command actuator 440 to implement at least the functionality of receiving information through a network adapter, processing the information from the two or more downhole logs through the processor according to the instructions stored in the memory to create a command, and for performing reservoir analysis according to the command. In some embodiments, the instructions can, when executed by the command actuator 440, cause the command actuator 440 to use one or more inversion procedures or techniques to perform reservoir analysis using the information received. In some embodiments, the instructions can, when executed by the command actuator 440, cause the command actuator 440 to use one or more analyses to determine the reservoir analysis using the one or more models.

In one or more embodiments, the command actuator 440 can work in conjunction with the processor 414 to implement the functionality described above. In some embodiments, the command actuator 440 can execute firmware code stored on the computing system 400, such as on the chip 405, the chip 421, and/or the processor 414. The functionality of the computing system 400 and/or the command actuator 440 can be in accordance with the processes of the present specification described herein. In the course of executing code, the processor 414 and/or the command actuator 440 can receive input from and provide output to a number of the remaining hardware units.

The computing system 400 can be implemented in an electronic device. Examples of electronic devices include servers, desktop computers, laptop computers, cloud-based computers, personal digital assistants (“PDAs”), mobile devices, smartphones, gaming systems, and tablets, among other electronic devices. The computing system 400 can be utilized in any data processing scenario including, stand-alone hardware, mobile applications, through a computing network, or combinations thereof. Further, the computing system 400 can be used in a computing network, a public cloud network, a private cloud network, a hybrid cloud network, other forms of networks, or combinations thereof. In one example, the processes provided by the computing system 400 can be provided as a service by a third party.

To achieve its desired functionality, the computing system 400 can include various other hardware components. Among these other hardware components can be a number of data storage devices or tangible, non-transitory computer readable medium 416, a number of peripheral device adapters 418, and a number of network adapters 420. These hardware components can be interconnected through the use of a number of electrical connections, busses, and/or network connections.

The chip 405, the chip 421, and/or the processor 414 can include the hardware and/or firmware/software architecture to retrieve executable code from the data storage device 416 and execute the executable code. The executable code can, when executed by the chip 405, the chip 421, and/or the processor 414, cause the chip 405, the chip 421, and/or the processor 414 to implement at least the functionality of receiving information through a network adapter, processing the information from the two or more downhole logs and performing reservoir analysis according to the command.

The data storage device 416 can store data such as executable program code that is executed by the processor 414, the command actuator 440, or other processing devices. The processor 414 can be a central processing unit that is to execute an operating system in the computing system 400. As will be discussed, the data storage device 416 can specifically store computer code representing a number of applications that the processor 414 and/or the command actuator 440 can execute to implement at least the functionality described herein.

In one or more embodiments, the data storage device 416 can include various types of memory modules, including volatile and nonvolatile memory. In one or more embodiments, the data storage device 416 of the present example can include Random Access Memory (“RAM”) 424, Read Only Memory (“ROM”) 423, and Hard Disk Drive (“HDD”) storage 428. Many other types of memory can also be utilized, and the present specification contemplates the use of many varying type(s) of memory in the data storage device 416 as can suit a particular application of the principles described herein. In certain examples, different types of memory in the data storage device 416 can be used for different data storage requirements. In one or more embodiments, in certain examples the processor 414 can boot from Read Only Memory (“ROM”) 426, maintain nonvolatile storage in the Hard Disk Drive (“HDD”) memory 428, and execute program code stored in Random Access Memory (“RAM”) 424. In examples, the chip 405, and the chip 421 can boot from the Read Only Memory (“ROM”) 426.

The data storage device 416 can include a computer readable medium, a computer readable storage medium, or a non-transitory computer readable medium, among others. In one or more embodiments, the data storage device 416 can be, an electronic, magnetic, optical, electromagnetic, infrared, or semiconductor system, apparatus, or device, or any suitable combination of the foregoing. More specific examples of the computer readable storage medium can include, for example, the following: an electrical connection having a number of wires, a portable computer diskette, a hard disk, a RAM, a ROM, an EPROM, a Flash memory, a portable compact disc read only memory (“CD-ROM”), an optical storage device, a magnetic storage device, or any suitable combination of the foregoing. In the context of this document, a computer readable storage medium can be any tangible medium that can contain, or store computer usable program code for use by or in connection with an instruction execution system, apparatus, or device. In another example, a computer readable storage medium can be any non-transitory medium that can contain or store a program for use by or in connection with an instruction execution system, apparatus, or device.

The hardware adapters 418, 420 in the computing system 400 can enable the processor 414 to interface with various other hardware elements, external and internal to the computing system 400. In one or more embodiments, the peripheral device adapters 418 can provide an interface to input/output devices, such as, for example, a display device 430, a mouse, and/or a keyboard. The peripheral device adapters 418 can also provide access to other external devices such as an external storage device, a number of network devices such as, for example, servers, switches, and routers, client devices, other types of computing devices, and combinations thereof.

The display device 430 can be provided to allow a user of the computing system 400 to interact with and implement the functionality of the computing system 400. Examples of display devices 430 can include a computer screen, a laptop screen, a mobile device screen, a personal digital assistant (“PDA”) screen, and/or a tablet screen, among other display devices 430.

The peripheral device adapters 418 can also create an interface between the processor 414 and the display device 430, a printer, or other media output devices. The network adapter 420 can provide an interface to other computing devices within, for example, a network, thereby enabling the transmission of data between the computing system 400 and other devices located within the network. The network adapter 420 can provide an interface to an external telecommunications network such as a cellular phone network or other radio frequency enabled network, thereby enabling the transmission of data between the computing system 400 and other external devices such as an external storage device, a number of network devices such as, for example, servers, switches, and routers, client servers, radio frequency enabled devices, other client devices, other types of computing devices, and combinations thereof.

The computing system 400 can further include a number of modules used in the implementation of the process and systems described herein. The various modules within the computing system 400 can include executable program code that can be executed separately. In this example, the various modules can be stored as separate computer program products. In another example, the various modules within the computing system 400 can be combined within a number of computer program products; each computer program product including a number of the modules.

While the present disclosure may be susceptible to various modifications and alternative forms, specific embodiments have been shown by way of example in the drawings and have been described in detail herein. However, it should be understood that the present disclosure is not intended to be limited to the particular forms disclosed. Rather, the present disclosure is intended to cover all modifications, equivalents, and alternatives falling within the spirit and scope of the present disclosure as defined by the following appended claims.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim can be not defined above, it should be given the broadest definition persons in the pertinent art have given that term as reflected in at least one printed publication or issued patent. Furthermore, all patents, test procedures, and other documents cited in this application are fully incorporated by reference to the extent such disclosure can be not inconsistent with this application and for all jurisdictions in which such incorporation can be permitted.

While certain preferred embodiments of the present invention have been illustrated and described in detail above, it can be apparent that modifications and adaptations thereof will occur to those having ordinary skill in the art. It should be, therefore, expressly understood that such modifications and adaptations may be devised without departing from the basic scope thereof, and the scope thereof can be determined by the claims that follow.

What is claimed is:

1. A process, comprising:
combining at least two downhole logs into input data;
using an interpretation method to convert the input data into interpretative data;
using elemental analysis to convert the interpretative data into at least one formation model;
acquiring formation properties from the at least one formation model;
creating a reservoir quality classification from the formation properties; and
directing downhole operations using the reservoir quality classification to select a preferred downhole operation location.

2. The process of claim 1, wherein the at least two downhole logs include one or more open-hole logs, one or more cased-hole logs, or a combination of one or more open-hole logs and one or more cased-hole logs.

3. The process of claim 1, wherein the at least two downhole logs are selected from an induction resistivity log, a bulk density log, an epithermal neutron porosity log, a spectroscopy log, and a nuclear magnetic resonance log.

4. The process of claim 1, wherein the interpretation method includes exploratory factor analysis.

5. The process of claim 1, wherein the interpretative data includes geological facies information.

6. The process of claim 1, wherein the elemental analysis includes sorting interpretative data according to geological facies information to provide sorted interpretative data and applying a logarithmic transformation and square function to the sorted interpretative data.

7. The process of claim 1, wherein the elemental analysis includes nuclear magnetic resonance factor analysis, determining porosity and fluid distribution, determining fluid volume, determining free and bound fluid, and a porosity partitioning and permeability analysis using the equations:
$${K}_{S D R} = {a ( φ )}^{2} {( d * {T}_{2 l m} )}^{2} and {K}_{macro} = {c ( φ )}^{2} {( ( {φ}_{micro} ) / ( {φ}_{m e s o} + {φ}_{micro} ) )}^{2} .$$

8. The process of claim 1, wherein the elemental analysis includes establishing T² cutoffs.

9. The process of claim 1, wherein the process further comprises validating the formation properties using mercury injection capillary pressure measurements of a core sample.

10. The process of claim 1, wherein the reservoir quality classification includes a quality rating system associated with formation depth.

11. The process of claim 10, wherein the quality rating system includes a carbonate reservoir porosity partitioning.

12. The process of claim 10, wherein the quality rating system includes a distribution of porosity and associated permeability of a carbonate reservoir.

13. The process of claim 10, wherein the preferred downhole operation location is based on the quality rating system.

14. The process of claim 1, wherein the elemental analysis includes a producible hydrocarbon porosity prediction.

15. The process of claim 1, wherein the elemental analysis includes a carbonate formation permeability prediction.
